(19) United States
(12) Patent Application Publication
(10) Pub. No.: US 2022/0035048 A1
(43) Pub. Date: Feb. 3, 2022

(54) REAL-TIME SELF CONTAINED SATELLITE-NAVIGATION-BASED RELATIVE-POSITION DETERMINATION

(71) Applicant: D.K. Schmidt & Associates LLC, Monument, CO (US)

(72) Inventor: David K. Schmidt, Monument, CO (US)

(73) Assignee: D.K. Schmidt & Associates LLC, Monument, CO (US)

(21) Appl. No.: 17/393,009

(22) Filed: Aug. 3, 2021

Related U.S. Application Data
(63) Continuation-in-part of application No. 16/194,765, filed on Nov. 19, 2018, now Pat. No. 11,105,930.
(60) Provisional application No. 62/607,637, filed on Dec. 19, 2017.

(51) Int. Cl. G01S 19/39; G01S 19/47; G05D 1/10

(52) U.S. Cl. CPC G01S 19/393; G05D 1/101; G01S 19/47

(57) ABSTRACT

Disclosed are methods of navigation by satellite positioning system without the aid of any ground-based facilities or supplemental data. An aircraft can autonomously define an approach path for navigation to a landing location by surveying a desired landing area prior to flight, and spatially and mathematically defining a vertical and inclined horizontal plane of interest, along with the target landing point. Also disclosed is a system for using satellite-derived position and velocity information to navigate an aircraft without ground-based facilities or data. Methods defining the approach path through alternate vertical geometries of interest are also disclosed.

### CROSS REFERENCE OF RELATED APPLICATIONS

The present application Continuation-In-Part of, and claims the benefit of priority to, U.S. Non-Provisional patent application Ser. No. 16/194,765 filed 19 Nov. 2018, which in turn claims the benefit of priority to U.S. Provisional Application No. 62/607,637 filed 19 Dec. 2017, both of which are hereby incorporated by reference in their entirety for all purposes as if fully set forth herein.

### FEDERAL SPONSORSHIP

This invention was made with Government support under contract NNX14AL36A awarded by NASA. The Government has certain rights in the invention.

### BACKGROUND OF THE INVENTION

### Field of the Invention

The present invention relates generally to navigation, and in particular, relates to navigation guidance onboard aircraft landing at airports lacking certain ground infrastructure in support of a precision approach.

### Relevant Background

Over the last several decades, small satellite-navigation receivers have been commonly employed to determine real-time inertial-position measurements of a carrier. The Global Positioning System (GPS) is an example of a satellite-based, worldwide all-weather radio positioning and timing system. The GPS system was designed to provide precise position, velocity, and timing information on a global common grid system to an unlimited number of adequately equipped users.

A GPS receiver is the key for a user to access the Global Positioning System. A conventional, single antenna GPS receiver supplies world-wide, highly accurate three-dimensional position, velocity, and timing information. In a benign radio environment, the GPS signal propagation errors and GPS satellite errors, including selective availability, serve as the bounds for positioning errors.

A “precision approach” is an approach that is aligned with the runway. A precision approach system provides course guidance, distance from runway, and elevation to a pilot or autopilot. The Instrument Landing System (ILS) is one of the most common precision approach systems. Other navigation devices and systems have been employed for decades for aviation application.

The ILS is a radio navigation system that provides measurements of the horizontal and vertical position offsets of a carrier (i.e., an aircraft) relative to two intersecting geometric virtual planar surfaces, one vertical and one slightly inclined from horizontal. The vertical planar surface, referred to as the localizer plane, is aligned azimuthally with the centerline of the runway on which the aircraft is to land, while the inclined horizontal planar surface, referred to as the glide-slope plane, is normal to the vertical plane and inclined at a fixed angle from horizontal equal to the required glide-slope angle of the aircraft during landing approach. The line of intersection of the planes is thusly directed to a target point on the runway near which the aircraft is to touch down. Some ILS installations also provide measurements of the range of the carrier from that target point. An ILS provides a navigation and guidance system intended to accurately deliver the aircraft to the runway threshold even in the presence of crosswinds and poor visibility.

The ILS system includes a ground-based component and a carrier-based component. The ground-based component provides the measurement of the carrier-position offset from the vertical (localizer) plane, as well as the measurement of the carrier-position offset from the inclined horizontal (glide-slope) plane. The carrier-based component consists of a receiver that receives and processes the information obtained from the ground transmitter, either displaying it to the pilot or providing it to an autopilot. So, the ILS requires both extensive ground-based components, and well as carrier-based components.

Satellite- or GPS-based systems, such as the Wide Area Augmentation System (WAAS) or the Ground Based Augmentation Systems (GBAS), are being developed to enable aircraft to rely on the UPS for various phases of flight, including precision approaches to any airport within its coverage area. Hence such systems can be used instead of an ILS. These systems require: a network of ground-based reference stations to improve the accuracy of the GPS-derived position measurements. Hence, these systems also require extensive ground-based components as well as carrier-based components.

The United States has also developed the U.S. Nationwide Differential GPS System (NDGPS) for obtaining GPS-based inertial-position measurements of ground and maritime vehicles. This system also requires a network of ground stations, similar to those used in the GBAS cited previously.

U.S. Pat. No. 6,239,745B1, “Satellite Landing System Having Instrument Landing System Look Alike Guidance,” Issued to D. Alexander Stratton, discloses a global navigation satellite system (GLASS) landing system (GLS) and methods of using the same to calculate a vertical deviation from the glide slope of the aircraft. This system requires extensive ground-based equipment at the airport location.

U.S. Pat. No. 20050182530A1, “Global Navigation Satellite System Landing Systems and Methods,” Issued to Timothy Murphy, discloses a method and system for performing satellite-supported landings in CAT WM type landing conditions. This system also requires extensive ground-based equipment at the airport location.

U.S. Pat. No. 570207A, “Apparatus and Method Using Relative GPS Positioning for Aircraft Precision Approach and Landing,” Issued to James D. Ward, discloses a relative GPS landing system for approach and of aircraft where an accurate site survey of the GPS platform is unavailable. Data containing information on all GPS satellites in view is uplinked from a ground station to an aircraft. A relative solution is derived at the aircraft. Based upon the calculated solution, aircraft guidance signals are generated for approach and landing of the aircraft at a desired point. This system involves the use of ground-based equipment, but not differentials-GPS equipment, at the airport location.

All the above satellite-based relative-position-measurement systems require extensive ground facilities and modified GPS carrier equipment. They are thus not available for aircraft operating in an area outside the range of measurement systems dependent on those ground-based facilities.

An alternative is put forth in U.S. Pat. No. 5,820,080A, “Precision Equivalent Landing System Using GPS and an Altimeter,” Issued to Ralph P. Eschenbach, discloses a precision equivalent landing system utilizing a satellite-based position determining system and altimeter coupled to an aircraft, which generates lateral and vertical position information of the aircraft with respect to a pre-defined landing approach path. This relative position information is provided to a graphic pilot display in the aircraft. Thus, this invention claims to provide an equivalent precision-landing system without requiring ground-based infrastructure at or near the airport. However, previously obtained information on the desired flight path must be provided from an independent source (e.g., published flight-path data from an airport or some other database.)

Therefore, current GPS-based landing systems rely on extensive databases to construct approaches allowing airborne carriers to navigate point-to-point from the air to the landing zone. As such, existing systems require substantial memory and processing resources, especially as more individual points are added to approaches to improve accuracy. Further, point-to-point navigation by GPS is inherently prone to positional errors, and often must be augmented by ground-based equipment to improve accuracy, especially when navigating near the ground or other obstacles.

Stand-alone GPS receivers are small and relatively inexpensive. Tiny, commercially available GPS chip sets small enough to fit into a cellular phone or hand-held computer but powerful enough to receive GPS satellite signals, are readily available, and now used in some cellular phones. However, such GPS receivers do not provide real-time position and velocity measurements relative to a selected position or to a selected geometric surface, so they cannot alone provide real-time landing guidance to an airborne carrier. Hence, a need exists for a self-contained, low cost, light-weight, satellite-based method and system for real-time, on-board, relative-position determination. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims

### SUMMARY OF THE DISCLOSED INVENTION

One embodiment of the present invention includes a system and associated methodology for determining onboard an aircraft real-time position and velocity of the aircraft relative to a previously defined geometric vertical and/or horizontal plane, and relative position to a reference point on the ground. It also includes the methodology for surveying the desired landing area prior to flight, and spatially and mathematically defining a vertical or horizontal plane of interest, along with the target landing point. As such the present invention can be used, among other things, to autonomously guide the aircraft to a landing location, or to aid a pilot in doing so, without the aid of any ground-based facilities.

One device utilized to implement the method includes two components. The first component provides satellite-derived measurements of inertial position and velocity and communicates that information electronically to a computing device. The second component interrogates and receives the measurements from the former device, performs prescribed calculations using those measurements, and outputs the desired results from these calculations in a format readable by an electronic autopilot or by a pilot-display device. Both of the above devices, plus the autopilot and/or pilot display, are presently commercially available, or may be assembled from commercially available components. The entire position-measurement and calculation process may be performed by the computing device in almost real time, subject to computational delays of a few milliseconds. Such a hardware package can include small MEMS- or micromachine-based hardware, along with a micro-processor, and thus can be light weight with low power requirements.

The present invention also includes a mathematical algorithm and process, to be executed by the computing device, for using the inertial position and velocity measurements obtained from the satellite-navigation-based measurements to derive the current position and velocity of an airborne aircraft coupled to the system, relative to a previously defined geometric vertical and/or inclined horizontal plane, and the position relative to a point of interest (POI) on the ground. The present invention also includes a process and mathematical algorithm for specifying, prior to flight, the location and azimuthal orientation of a geometric vertical and/or horizontal plane of interest, and the inertial position of a point of interest (POI) on the ground.

Finally, the present invention also includes a method for specifying the vertical or horizontal geometric plane of interest and a point on that plane, such that the aircraft will be guided to a desired landing location. This methodology thus constitutes a landing-site survey performed using embodiments of the disclosed system. In the case of the system being coupled to a UAV, for example, the UAV itself may be moved as needed to perform the survey. In the case of a larger vehicle, the device of the disclosed invention may be designed to be easily removed from the aircraft and moved as needed to perform the survey, and then re-installed on the aircraft.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 presents three intersecting geometric planes in an ILS as would be known to one of ordinary skill in the relevant art;

FIGS. 2A and 2B are block diagrams of a representative micro-device package in accordance with one or more embodiments of the disclosed invention;

FIG. 3 shows a vertical plane of interest and point of interest (POI), according to one embodiment of the disclosed invention;

FIG. 4 depicts an inclined horizontal plane of interest and point of interest (POI), according to one embodiment of the disclosed invention;

FIG. 5 illustrates the normal offset distance d_{V} from a vertical plane, along with the slant range R_{V} from a POI, according one embodiment of the disclosed invention;

FIG. 6 is a sketch indicating the normal offset distance dx from an inclined horizontal plane, along with the slant Range R_{H} from a POI, according to one embodiment of the disclosed invention;

FIG. 7 diagrams a trajectory of interest consisting of two straight trajectory segments, including their respective POI's, according to one embodiment of the disclosed invention; and

FIG. 8 shows a vertical cylindrical surface of interest with a POI on the surface, according to one embodiment of the disclosed invention.

The Figures depict embodiments of the disclosed invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

A system and associated methodology for determining, onboard an aircraft, real-time position and velocity of the aircraft relative to a previously defined geometric vertical and/or horizontal plane, and relative position to a reference point on the ground is hereafter described by way of example. A methodology for surveying the desired landing area prior to flight, and spatially and mathematically defining a vertical or horizontal plane of interest, along with the target landing point is another aspect of the present invention disclosed hereafter. As such the present invention can be used to, among other things, autonomously guide an aircraft to a landing location, or to aid a pilot in doing so, without the aid of any ground-based facilities.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to provide navigational guidance. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

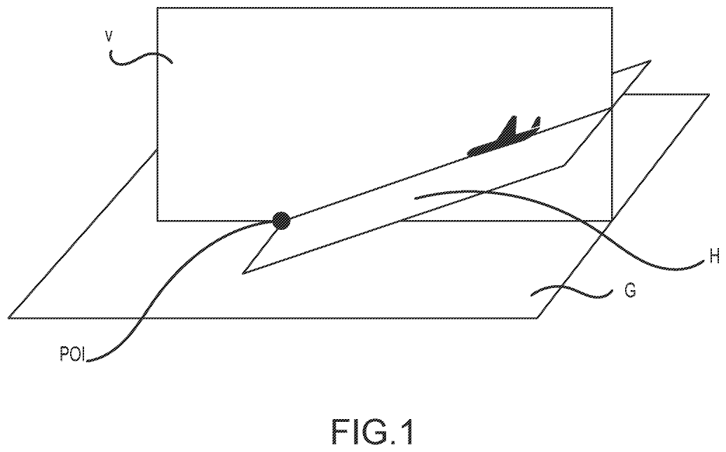

Existing Instrument Landing Systems (ILS), used to guide an aircraft on a precision approach, are based on the geometry presented in FIG. 1. This figure shows three intersecting geometric planes: the ground plane labeled G, the glide-slope plane labeled H, and the vertical or localizer plane labeled V. The desired approach path for the aircraft is coincident with the line of intersection of the glide-slope and localizer planes, or H and V, and a small image of an aircraft is shown position along this line. The ILS provides real-time measurements of the vertical and horizontal position offsets from these two geometric planes, plus a real-time measurement of the slant range to the desired target point or point of interest (POI) shown. As explained previously, newer Ground Based Augmentation Systems (GBAS) eliminate the need for a conventional ILS, but the GBAS also requires dedicated ground-based facilities.

A key application of the present invention is to provide a low-cost, light-weight alternative to the use of an ILS or GBAS by employing a self-contained, light-weight system hardware package that can be easily carried onboard an aircraft, and in particular, a small unmanned aerial vehicle (UAV). In addition, the system could be easily extracted from an aircraft, if necessary, for a pre-flight site survey. Therefore, the present invention allows a user to operate an aircraft independently of dedicated ground facilities. The generality of the invention also allows it to be applied to other applications yet unidentified.

System

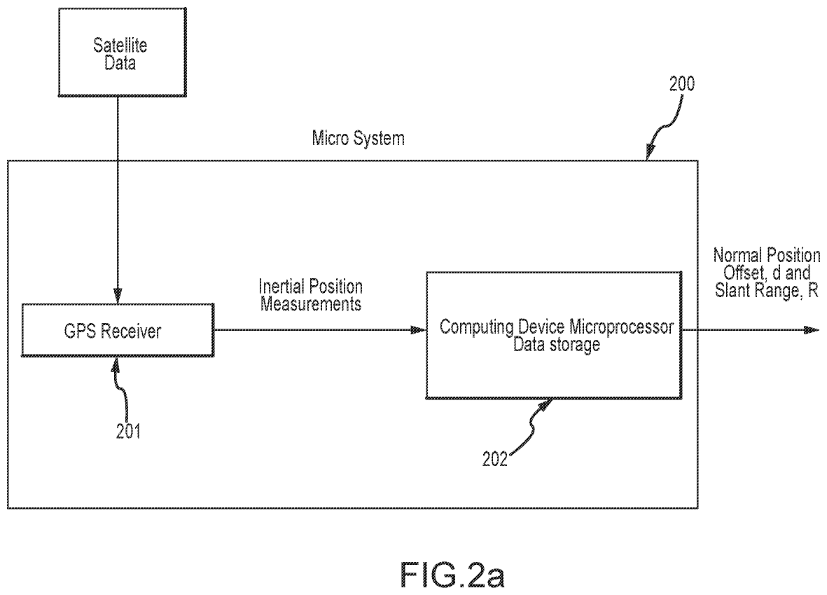

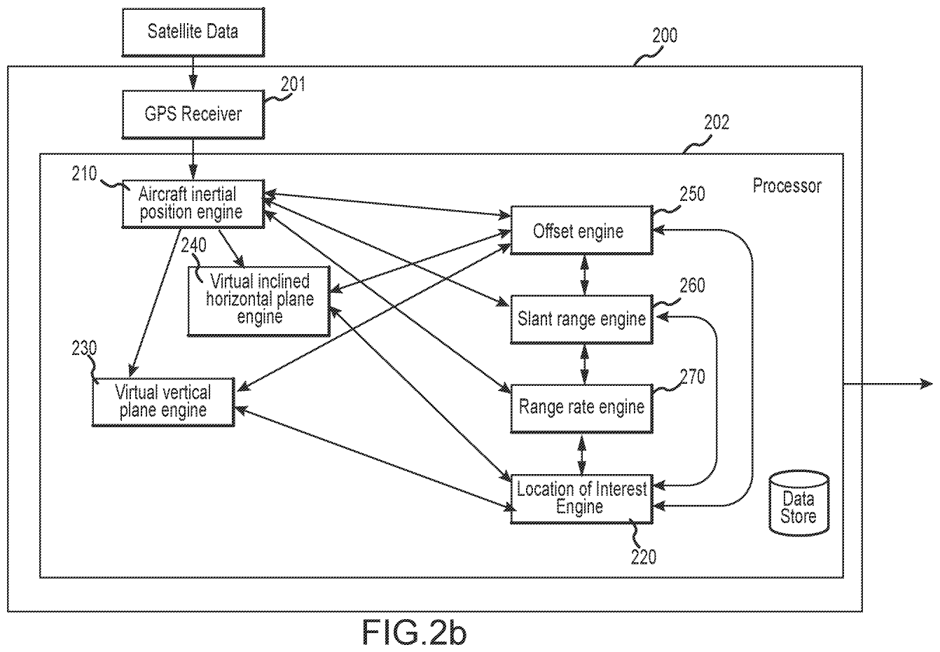

The herein disclosed invention includes a system 200, depicted in FIGS. 2A and 2B, comprising two readily available components. The first component is a satellite-navigation receiver 201 capable of providing satellite-derived real-time measurements of inertial position and velocity of the receiver and relaying that information electronically to a computing device 202. The second component is the said computing device 202 that, operating in real time, can interrogate and receive the measurements from the receiver 201, perform prescribed calculations using those measurements, store data for later retrieval, and output the desired results from these calculations in some readable format.

FIG. 2B presents a more detailed view of functional engines that interact and are communicatively coupled with the processor, data store, and GPS data. These functional engines perform tasks that allow the system to ascertain the position and velocity of the aircraft with respect to a terminal target location, which is approached via a virtual path derived from a virtual vertical plane and a virtual inclined horizontal plane. The GPS receiver 201 provides data to an aircraft inertial position engine 210 that identifies the aircraft location in inertial space. A location of interest engine 220 identifies a terminal target location on a plane of interest. This terminal target location, along with the aircraft inertial position are communicated to other aspects of the system to determine the aircraft's location relative to the virtual path.

The virtual vertical plane engine 230 crafts a vertical plane that includes, as a point on the plane, the terminal target location. Similarly, the virtual inclined horizontal plane engine 240 creates an inclined plane, also inclusive of the terminal target location. Using aircraft inertial position as determined by the aircraft inertial position engine 210 and the planes crafted by the virtual vertical plane engine 230 and the virtual inclined horizontal plane engine 240, the offset engine 250 determines an offset measurement of the aircraft's position relative to each plane.

At the same time, the slant range engine 260 and the range rate engine 270, again using data from the aircraft inertial position engine 210 and the location of interest engine 220 can determine distance between the aircraft and the terminal target location and rate at which the aircraft is moving relative to the target location.

The entire position-measurement and calculation process can be performed in almost real time, subject to computational delays of a few milliseconds. Both above devices, plus an autopilot and/or pilot display, are presently commercially available, or may be assembled from commercially available components. Such a system and autopilot can be small micro electrical machine (MEMS)-based hardware, along with a microprocessor, and can be light weight with low power requirements. Accordingly, one embodiment of the present invention could be entirely coupled to a UAV.

A second embodiment of the present invention includes a micro system 200 that can be easily removed from, and then re-coupled to, a piloted aircraft equipped with an onboard moving map or instrument landing-type pilot display. Removal allows for the system to be utilized for the landing-site surveys. Another embodiment of the present invention includes the micro-device hardware package 200 coupled to a UAV, and the computing device 202 communicating with a ground-based laptop computer or display monitor used by the UAV pilot.

Site Selection and Site Survey

As an initial step, the invention methodology includes a mathematical description of one or more geometric planes of interest, along with a terminal point of interest (POI) on the ground at the landing site when aircraft landing is the application in question. Mathematically, a geometric plane can be defined from the knowledge of the position of three points on that plane. Those three points are preferably determined by means of a landing-site survey using the micro system 200 prior to flight. The user first selects a geometric plane of interest and a point of interest (POI). Then the user surveys these items of interest using satellite-based measurements of the inertial positions of two inertial locations on the plane of interest, where one of these locations may also be the selected point of interest (POI). The inertial position of a third location of interest on the plane of interest is then derived from the previous two satellite-navigation-based measurements and from the definition of the plane of interest. Finally, this measured and derived position data are stored for later recall by the computing device 202. The plane-and-point-definition survey process is accomplished through the use of the system 200 described, not including an autopilot or pilot display, and the methodology now to be further described according to one embodiment of the present invention.

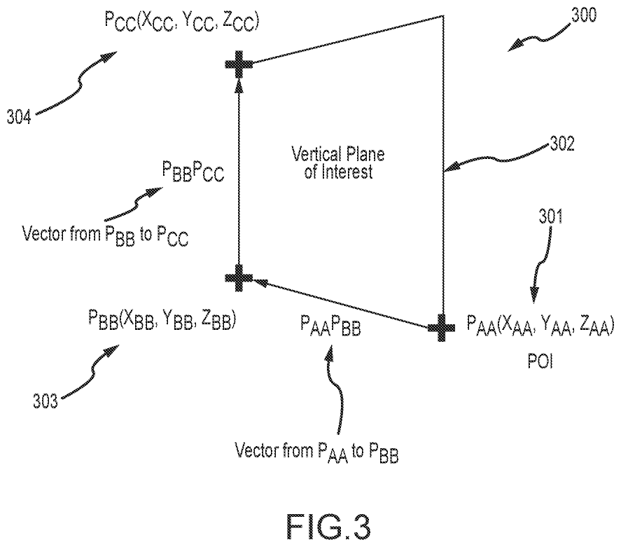

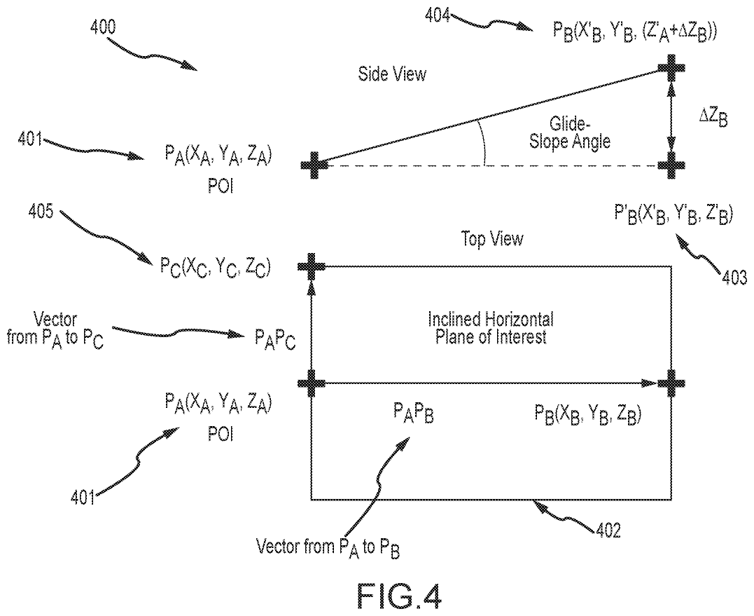

Consider an example application mimicking an ILS approach, in which a geometric plane of interest would be a localizer and/or glide-slope plane, and the point of interest (POI) could be the desired touchdown location. For each geometric plane to be defined (e.g., localizer plane, or glide-slope plane), this POI could also be one of the locations of interest (LOIs). With reference to FIGS. 3 and 4, the location of this POI is denoted P_{AA} 301 or P_{A} 401, and the system 200 is used to measure the inertial position of this POI. Thus, the position denoted as P_{AA}(x_{AA},y_{AA},z_{AA}) in FIG. 3 or P_{A}(x_{A},y_{A},z_{A}) in FIG. 4 is then known, where x, y, and z are the coordinates measured along the three orthonormal directions used in the satellite-navigation-based measurements of the inertial positions. For example, these directions might be North, East, and Down.

Next, the second LOI is selected some distance from the first LOI (or POI). In the case of a vertical plane of interest 302, this location would correspond to P_{BB} 303 as shown in FIG. 3. In the case of an inclined horizontal plane of interest 402, this location would correspond to P′_{B} 403 as shown in FIG. 4. The system 200 measures the inertial position of either of these LOIs, and thus the position denoted as P_{BB}(x_{BB},y_{BB},z_{BB}) 303 or P′_{B}(x′_{B},y′_{B},z′_{B}) 403 is then known. If the plane of interest is an inclined horizontal plane, by selecting a desired glide-slope angle the elevation denoted Δz_{B} in FIG. 4 can be calculated from trigonometry knowing the horizontal distance between P_{A} 401 and P′_{B} 403. Then the position of the second LOI P_{B}(x′_{B},y′_{B},(z′_{B}+Δz_{B})) 404 is now known, the coordinates x_{B}, y_{B}, and z_{B} being now defined.

Note that the accuracy of the final results depends on the distance chosen between the LOIs. The LOIs should therefore be located sufficiently far enough apart to allow the system to accurately describe the planes of interest. The determination of LOI spacing distance should account for system accuracy, including the accuracy of the GPS location, any inherent calculation error, pilot error, or other significant source of error. In addition, accuracy is also improved when the device used to measure the x,y,z coordinates of these LOIs is the same device that will be coupled to the aircraft in flight.

A third location of interest (LOI) can now be derived from the aforementioned measurements of the coordinates of P_{AA} 301 and P_{BB} 303 or P_{A} 401 and P_{B} 404, and from the properties of the geometric plane of interest. This third LOI will lie on the geometric plane of interest and must not lie along the infinite line aligned with the vector P_{AA}P_{BB}, shown in FIG. 3, or P_{A}P_{B} in FIG. 4. With reference to FIG. 3, for which the geometric plane of interest is normal to the ground plane, the third LOI P_{CC} 304 may be taken to be a point in space directly above either P_{AA} 301 or P_{BB} 303. If P_{CC} 304 is taken to be a distance Δz above P_{BB} 303, then

P_{CC}(x_{CC},y_{CC},z_{CC})=P_{CC}(x_{BB},y_{BB},(z_{BB}+Δz)) 1

and x_{CC}, y_{CC}, and z_{CC} have been determined. If P_{CC} 304 is taken to be a distance Δz above P_{AA} 301, then

P_{CC}(x_{CC},y_{CC},z_{CC})=P_{CC}(x_{AA},y_{AA},(z_{AA}+Δz)) 2

In this fashion the coordinates x_{CC}, y_{CC}, and z_{CC} are now defined and can be stored, along with the measured values for x_{AA}, y_{AA}, and z_{AA} and x_{BB}, y_{BB}, and z_{BB}, for later use by the computing device 202.

When the plane of interest are instead an inclined horizontal plane 402, considering FIG. 4, the third LOI, or P_{C} 405 could lie on the ground plane (i.e., z_{C}=z_{A}), and on a line through the POI at P_{A} 401 and normal to the vector P_{A}P_{B}. So x_{C} and y_{C} may be found using trigonometry knowing x_{A} and y_{A}, along with the azimuth angle of the vector P_{A}P_{B}.

The steps to complete this first part of the methodology are then:
Select a plane of interest and a terminal target point of interest (POI).
Using the system 200, survey the plane and point of interest by obtaining the satellite-navigation-based measurements of the inertial positions of two locations of interest (LOIs) on that plane of interest, along with the point of interest (POI).
Denote the measured inertial positions of these two locations of interest (LOIs) on the plane of interest P_{A}(x_{A},y_{A},z_{A}) and P_{B}(x_{B}, y_{B}, z_{B}).
From the geometric properties of the plane of interest, select a third location of interest (LOI) such that it lies on the plane of interest and does not lie on the infinite line aligned with the vector P_{AA}P_{BB} or P_{A}P_{B}. Denote the position of this location as P_{CC}(x_{CC}, y_{CC}, z_{CC}) or P_{C}(x_{C}, y_{C}, z_{C}), depending on the type of plane of interest.
From the result of the above, and knowing P_{AA}(x_{AA}, y_{AA}, z_{AA}) and P_{BB}(x_{BB}, y_{BB}, z_{BB}) or P_{A}(x_{A}, y_{A}, z_{A}) and P_{B}(x_{B}, y_{B}, z_{B}), derive the coordinates x_{C}, y_{C}, z_{C} or x_{C}, y_{C}, z_{C}, and note that all nine x,y,z coordinates for the three LOIs are now known. When the POI does not lie on the plane of interest, measure its z,y,z coordinates with the system 200.
Store the measured or derived values for these coordinates for later use by the computing device 202 in the micro-system 200.

Deriving the Real-Time Relative Position and Velocity

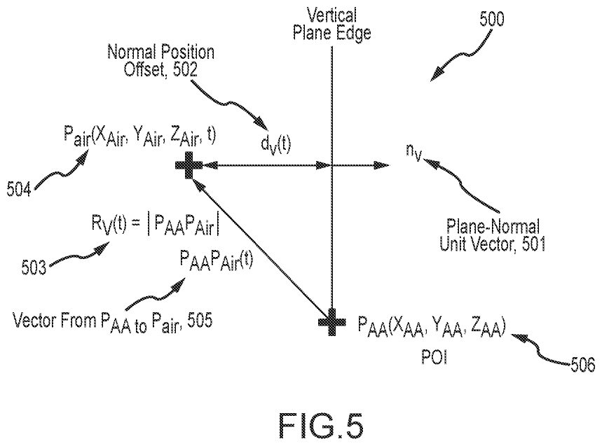

The next part of the invention methodology describes the algorithm for deriving the real-time normal-position offset d, and its time rate of change, of the onboard system 200 from the previously defined plane(s) of interest. First note by referring to FIGS. 3 and 5 that the unit vector normal to a vertical plane of interest 302, or ny 501, can be found from the following vector equation and from the properties of the vector cross product (x).

$${n}_{V} = \frac{{P}_{A A} {P}_{B B} \times {P}_{B B} {P}_{C C}}{\vert {P}_{A A} {P}_{B B} ‖ {P}_{B B} {P}_{C C} \vert} \qquad 3$$

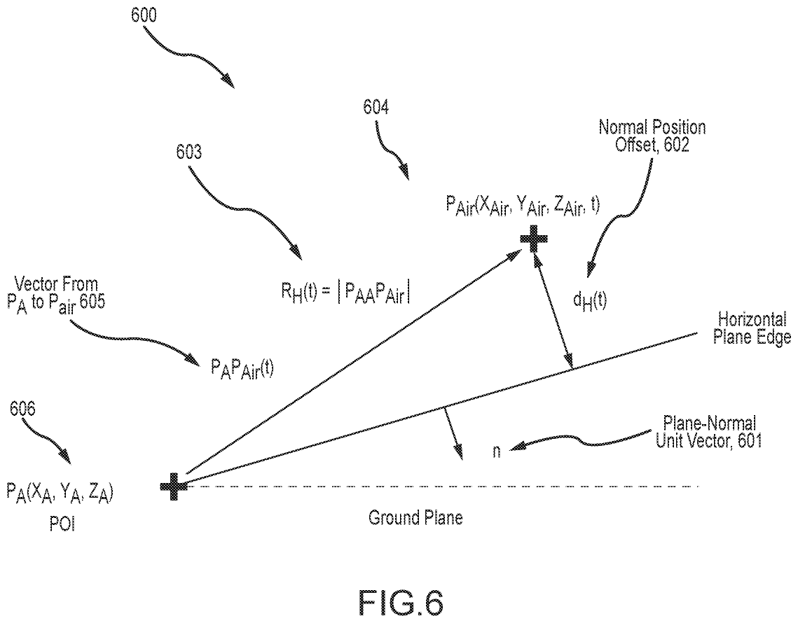

Correspondingly, by referring to FIGS. 4 and 6 note that the unit vector normal to an inclined horizontal plane of interest 402, or n_{H} 601, can be found from a similar vector equation, or

$${n}_{H} = \frac{{P}_{A} {P}_{C} \times {P}_{A} {P}_{B}}{\vert {P}_{A} {P}_{C} ‖ {P}_{A} {P}_{B} \vert} \qquad 4$$

In the above two equations, PᵢPⱼ is the vector from location Pᵢ(xᵢ, yᵢ, zᵢ) to location Pⱼ(xⱼ, yⱼ, zⱼ), and
   |PᵢPⱼ| denotes the magnitude of the vector PᵢPⱼ.

Note that in terms of the measured x,y,z coordinates of the LOIs, the vectors in Eqns. 3 and 4 are

P_{A}P_{B}=(x_{B}−x_{A})i_{I}+(y_{B}−y_{A})j_{I}+(z_{B}−z_{A})k_{I}≡ΔX_{A,B}i_{I}+ΔY_{A,B}j_{I}+ΔZ_{A,B}k_{I}

P_{A}P_{C}=(x_{C}−x_{A})i_{I}+(y_{C}−y_{A})j_{I}+(z_{C}−z_{A})k_{I}≡ΔX_{A,C}i_{I}+ΔY_{A,C}j_{I}+ΔZ_{A,C}k_{I}

P_{AA}P_{BB}=(x_{BB}−x_{AA})i_{I}+(y_{BB}−y_{AA})j_{I}+(z_{BB}−z_{AA})k_{I}≡ΔX_{AA,BB}i_{I}+ΔY_{AA,BB}j_{I}+ΔZ_{AA,BB}k_{I}

P_{BB}P_{CC}=(x_{CC}−x_{BB})i_{I}+(y_{CC}−y_{BB})j_{I}+(z_{CC}−z_{BB})k_{I}≡ΔX_{BB,CC}i_{I}+ΔY_{BB,CC}j_{I}+ΔZ_{BB,CC}k_{I} 5

where i_{I}, j_{I}, and k_{I} are the three mutually orthogonal unit vectors defining an inertial reference frame aligned with the reference frame used by the satellite-navigation device 201 (e.g., North, East, Down). Likewise, the magnitudes of these vectors may be found from

|P_{A}P_{B}|=\sqrt{P_{A}P_{B}·P_{A}P_{B}}=(ΔX_{A,B}²+ΔY_{A,B}²+ΔZ_{A,B}²)^{1/2}

|P_{A}P_{C}|=\sqrt{P_{A}P_{C}·P_{A}P_{C}}=(ΔX_{A,C}²+ΔY_{A,C}²+ΔZ_{A,C}²)^{1/2}

|P_{AA}P_{BB}|=\sqrt{P_{AA}P_{BB}·P_{AA}P_{BB}}=(ΔX_{AA,BB}²+ΔY_{AA,BB}²+ΔZ_{AA,BB}²)^{1/2}

|P_{BB}P_{CC}|=\sqrt{P_{BB}P_{CC}·P_{BB}P_{CC}}=(ΔX_{BB,CC}²+ΔY_{BB,CC}²+ΔZ_{BB,CC}²)^{1/2} 6

where • denotes the vector dot product.

Therefore, by knowing the nine measured x,y,z coordinates corresponding to the three LOIs on the plane of interest, all previously determined during a site-survey process, the unit vectors n_{V} 501 or n_{H} 601 can be found from Eqns. 3 or 4, respectively. Regarding Eqn. 4, for example, the cross product in the numerator yields

$${P}_{A} {P}_{C} \times {P}_{A} {P}_{B} = det [ \begin{matrix}{i}_{I} & {j}_{I} & {k}_{I} \\ Δ {X}_{A , C} & Δ {Y}_{A , C} & Δ {Z}_{A , C} \\ Δ {X}_{A , B} & Δ {Y}_{A , B} & Δ {Z}_{A , B}\end{matrix} ] = ( Δ {Y}_{A , C} Δ {Z}_{A , B} - Δ {Z}_{A , C} Δ {Y}_{A , B} ) {i}_{I} + ( Δ {Z}_{A , C} Δ {X}_{A , B} - Δ {X}_{A , C} Δ {Z}_{A , B} ) {j}_{I} + ( Δ {X}_{A , C} Δ {Y}_{A , B} - Δ {Y}_{A , C} Δ {X}_{A , B} ) {k}_{I} \qquad 7$$

which, along with the appropriate expressions in Eqns. 6, allows for Eqn. 4 to be evaluated. Similarly, Eqn. 3 may be evaluated as well.

Now referring to FIGS. 5 and 6, the position offset distance d_{V}(t) 502 or d_{H}(t) 602 and range to the point of interest (POI) R_{V}(t) 503 or R_{H}(t) 603 may be found. Let the current inertial position at time t of the airborne micro system 200 be denoted as P_{Air}(x_{Air}, y_{Air}, z_{Air}, t) 504 or 604, depending on the plane of interest.

Similar to Eqns. 5, the time-dependent, relative-position vector from the POI P_{A} 506 or P_{A} 606 to the carrier position P_{Air}, or P_{AA}P_{Air}(t) 505 or P_{A}P_{Air}(t) 605, can now be expressed as

P_{AA}P_{Air}(t)=ΔX_{AA,Air}(t)i_{I}+ΔY_{AA,Air}(t)j_{I}+ΔZ_{AA,Air}(t)k_{I}

or

P_{A}P_{Air}(t)=ΔX_{A,Air}(t)i_{I}+ΔY_{A,Air}(t)j_{I}+ΔZ_{A,Air}(t)k_{I} 8

(It is assumed here that the POIs are also LOIs on the planes of interest.) So still referring to FIGS. 5 and 6, the time-dependent normal-position offset from the geometric plane of interest, d_{V}(t) 502 or d_{H}(t) 602, may be found from the properties of the vector dot product to be

d_{V}(t)=n_{V}·P_{AA}P_{Air}(t)

d_{H}(t)=n_{H}·P_{A}P_{Air}(t) 9

Expressing the vectors n_{V} and P_{AA}P_{Air}(t) in terms of their inertial components, that is, letting

n_{V}=X_{nV}i_{I}+Y_{nV}j_{I}Z_{nV}k_{I}

P_{AA}P_{Air}(t)=X_{AA,Air}(t)i_{I}+Y_{AA,Air}(t)j_{I}+Z_{AA,AIR}(t)k_{I} 10

the normal-position offset d_{V}(t) 502 is found from Eqn. 9 to be

d_{V}(t)=n_{V}·P_{AA}P_{Air}(t)=X_{nV}X_{AA,Air}(t)+YₙᵥY_{AA,Air}(t)+Z_{nV}Z_{AA,Air}(t) 11

And similarly, d_{H}(t) 602 may be determined as well.

Note that the sign of d_{V}(t) 502, as found from Eqn. 11, will determine whether the system 200 coupled to the aircraft is to the left or the right of the vertical plane of interest shown in FIG. 5, while the sign of d_{H}(t) 602 will determine whether the onboard system 200 is above or below the inclined horizontal plane of interest shown in FIG. 6. With the LOIs and vectors as shown in FIGS. 3-6, a positive d_{V} 502 indicates that the onboard system is to the right of the vertical plane, as viewed from the POI P_{AA} 506. Similarly, a positive d_{H} 602 indicates that the onboard system 200 is below the inclined horizontal plane, as viewed from the POI P_{A} 606.

To calculate the rate of change of the offset distance d_{V}(t) 502 or d_{H}(t) 602, that is, \dot{d}_{V}(t) or \dot{d}_{H}(t), respectively, write the inertial velocity of the onboard system 200 in terms of the rates of change of its inertial-position coordinates, or

\dot{P}_{Air}(\dot{x}_{Air},\dot{y}_{Air},ż_{Air},t)

in which \dot{x}_{Air}, \dot{y}_{Air}, and ż_{Air} are the orthonormal inertial velocity components measured by the satellite-navigation receiver 201 corresponding to the measured x,y,z components of inertial position. Consistent with this notation, the inertial rate of change of the relative-position vector P_{AA}P_{Air}, written as P_{AA}\dot{P}_{Air}, may be expressed as

P_{AA}\dot{P}_{Air}(t)=\dot{x}_{Air}(t)i_{I}+\dot{y}_{Air}(t)j_{I}+ż_{Air}(t)k_{I} 12

And consistent with the first of Eqns. 9 and of Eqns. 10, the rate of change of the offset distance d_{V}(t) 502 may be expressed as

\dot{d}_{V}(t)=n_{V}·P_{AA}\dot{P}_{Air}(t)=(X_{nV}\dot{x}_{Air}(t)+Y_{nV}\dot{y}_{Air}(t)+Z_{nV}ż_{Air}(t)) 13

In like manner, the rate of change of d_{H}(t) 602 may be determined as well.

Note that the signs of d_{V}(t) 502 and of its rate of change, \dot{d}_{V}(t), as found from Eqns. 11 and 13, will determine whether the onboard system 200 is moving toward or away from the vertical plane of interest, while the sign of d_{H}(t) 602 and its rate of change, \dot{d}_{H}(t), will determine whether the onboard micro system 200 is moving toward or away from the inclined horizontal plane of interest.

Finally, the slant range R_{V}(t) 503 or R_{H}(t) 603 of the onboard system 200 relative to the selected point of interest (POI) (for example, P_{AA} 506 or P_{A} 606, respectively) is given by

R_{V}(t)=|P_{AA}P_{Air}(t)|=\sqrt{P_{AA}P_{Air}(t)·P_{AA}P_{Air}(t)}

or

R_{H}(t)=|P_{A}P_{Air}(t)|=\sqrt{P_{A}P_{Air}(t)·P_{A}P_{Air}(t)} 14
depending on the plane of interest.

Note that Eqns. 8 through 14 are all calculated in real time using the real-time position updates for P_{Air} obtained from the satellite-based receiver 201, and hence the relative offset distances d(t), relative velocities \dot{d}(t), and slant ranges R(t) are all available onboard the aircraft and may be used in autonomous guidance-and-control algorithms or displayed to the pilot.

Non-Landing Applications

The foregoing discussion was presented in the context of an aircraft-landing application. But other applications of the present invention clearly are possible. As one example, consider a more general navigation application still involving a straight target trajectory to be followed by an aircraft, but with the termination point, or target POI, at some altitude above the ground, instead of a landing location. Furthermore, such target-trajectory segments can be linked together, for example, to define a segmented trajectory to be followed by the aircraft.

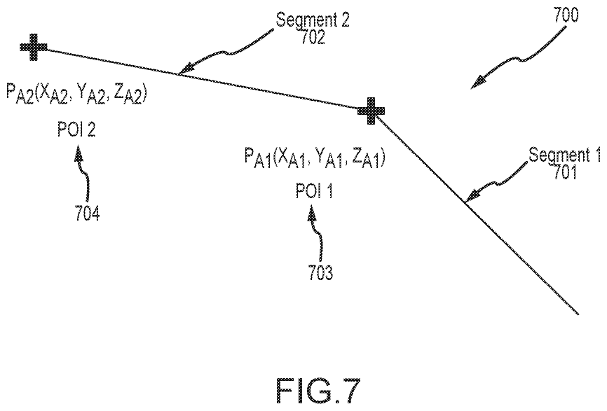

FIG. 7 depicts such an embodiment showing a segmented trajectory 700 comprising two straight-line segments 701 and 702, with each segment having their respective terminal points of interest (POIs) 703 and 704.

Since all such examples would involve straight target trajectory segments, all the relative-position algorithms presented previously apply directly. Only the location of the target POI(s) differs. The algorithms presented herein would be applied sequentially, as the aircraft moves from one straight-line segment to the next.

Other Virtual-Surface Geometries

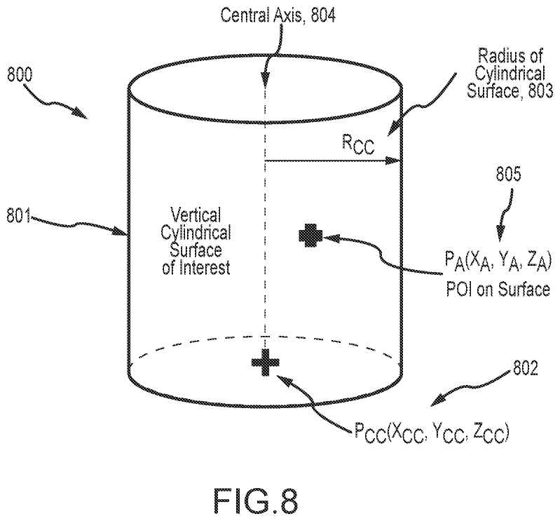

The foregoing discussion considered straight target trajectory segments, with planar virtual surfaces used to define the target segment. In another embodiment of the present invention, the virtual vertical surface can be a vertical cylinder rather than a vertical plane. In such an instance the intersection of that surface with an inclined horizontal plane defines a circular trajectory when viewed from above. In this case, the termination POI 805 would lie on the cylindrical surface 801, as shown in FIG. 8. Other virtual vertical surfaces in addition to a plane or cylinder may be useful for constructing approaches or navigation routes, and any virtual vertical surface definable by the mathematical techniques outlined herein and useful for navigation are possible and contemplated.

Given the inertial location of the cylinder center P_{CC}(x_{CC},y_{CC},z_{CC}) 802 and the radius of the cylinder R_{CC} 803, the current lateral-position offset d_{C}(t) of an aircraft at location P_{Air}(x_{Air},y_{Air},z_{Air},t) from the cylindrical surface can be shown to be given by

d_{C}(t)=R_{CC}−|P_{Air}P_{CC}| 15

when the aircraft is traveling clockwise around the cylinder. Here, P_{Air}P_{CC} is the vector from the current aircraft inertial location P_{Air}(x_{Air},y_{Air},z_{Air},t) to the central axis 804 at the aircraft's altitude. That is, this vector would always lie in a horizontal plane at the aircraft altitude. Using principles presented herein and in one embodiment of the present invention, relative-position algorithms can be applied for cases involving flight along circular trajectory segments.

The concepts in this disclosed invention not only apply to flight-trajectory geometries defined using (virtual) planar and/or cylindrical surfaces, but also apply to much more general trajectory geometries. For example, one could conceive of geometries described by the intersection between any curvilinear vertical and any curvilinear inclined horizontal surface, whose surface shapes (e.g., local position and slope of the surface) can be defined mathematically.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media or may be distributed from the memory or storage of one computer system over a network of some type to other computer systems for use by such other systems. Alternatively, the programming code may be embodied in the memory of the device including firmware and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

An exemplary system for implementing the invention includes a computing device such as the form of a conventional personal computer, or the like, including a processing unit, a system memory, and a system bus that couples various system components, including the system memory to the processing unit. The system bus may be any of several types of bus structures including a memory bus or memory controller, a peripheral bus, and a local bus using any of a variety of bus architectures. The system memory generally includes read-only memory (ROM) and random-access memory (RAM). A basic input/output system (BIOS), containing the basic routines that help to transfer information between elements within the personal computer, such as during start-up, is stored in ROM. The computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

While there have been described above the principles of the present invention in conjunction with a self-contained satellite-navigation-based system and methodology for real-time relative position determination, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

A method for satellite based precision relative navigation of an aircraft, comprising:
defining a target trajectory independent of ground-based navigation infrastructure, comprising defining a terminal target, a vertical plane, and an inclined horizontal plane, wherein the vertical plane and the inclined horizontal plane are perpendicular to each other and intersect along a line ending at the terminal target;
locating the aircraft relative to the target trajectory using an aircraft inertial position and an aircraft inertial velocity as measured by a satellite-based position determination system, comprising determining a lateral position offset, a lateral position offset rate, a vertical position offset, and a vertical position offset rate, wherein the lateral position offset and the lateral position offset rate are an aircraft position and velocity, respectively, relative to the vertical plane, and wherein the vertical position offset and the vertical position offset rate are an aircraft position and velocity, respectively, relative to the inclined horizontal plane; and
locating the aircraft relative to the terminal target using an aircraft inertial position and an aircraft velocity as measured by a satellite-based position determination system, comprising determining a slant range and a slant range rate, wherein the slant range and the slant range rate are an aircraft position and velocity, respectively, relative to the terminal target;
navigating to the terminal target, using a machine onboard the aircraft, wherein the machine is an autopilot coupled to a flight control system operable for controlling the aircraft.

The method according to paragraph [094], further comprising displaying, using the machine, a visual representation of the lateral position offset relative to the vertical plane, the vertical position offset relative to the inclined horizontal plane, and the slant range relative to the terminal target.

The method according to paragraph [094], wherein the terminal target is a location defined by P_{A}(x_{A}, y_{A}, z_{A}) and P_{AA}(x_{AA}, y_{AA}, z_{AA}) and wherein the vertical plane is a first geometric surface defined by P_{AA}(x_{AA}, y_{AA}, z_{AA}), P_{BB}(x_{BB}, y_{BB}, z_{BB}), and P_{CC}(x_{CC}, y_{CC}, z_{CC}) and wherein the inclined horizontal plane is a second geometric surface defined by P_{A}(x_{A}, y_{A}, z_{A}), P_{B}(x_{B}, y_{B}, z_{B}), and P_{C}(x_{C}, y_{C}, z_{C}), and wherein n_{V} is a first unit vector that is normal to the vertical plane, and n_{H} is a second unit vector that is normal to the inclined horizontal plane, and wherein n_{V} and n_{H} are determined by

$${n}_{V} = \frac{{P}_{A A} {P}_{B B} \times {P}_{B B} {P}_{C C}}{\vert {P}_{A A} {P}_{B B} ‖ {P}_{B B} {P}_{C C} \vert} {n}_{H} = \frac{{P}_{A} {P}_{C} \times {P}_{A} {P}_{B}}{\vert {P}_{A} {P}_{C} ‖ {P}_{A} {P}_{B} \vert}$$

and define the vertical plane and the inclined horizontal plane, respectively, wherein PᵢPⱼ is the vector from location Pᵢ(xᵢ, yᵢ, zᵢ) to location Pⱼ(xⱼ, yⱼ, zⱼ), and |PᵢPⱼ| denotes the magnitude of the vector PᵢPⱼ.

The method according to paragraph [094], wherein defining the target trajectory further includes identifying three locations of interest defining a vertical plane, and three locations of interest defining an inclined horizontal plane, and selecting a seventh location of interest defining a terminal target, wherein the seventh location of interest is located on both the vertical plane and the inclined horizontal plane.

The method according to paragraph [097], wherein the slant range and the slant range rate from said terminal target to the aircraft position is independent of the target trajectory.

The method according to paragraph [097], wherein the vertical position offset and lateral position offset from the inclined horizontal plane and the vertical plane, respectively, are based on an aircraft inertial position and a relative aircraft position that is normal to the vertical plane and normal to the inclined horizontal plane.

The method according to paragraph [094], wherein determining the vertical position offset and lateral position offset is void of any data derived from ground-based signals or an externally derived database.

The method according to paragraph [094], wherein determining the vertical position offset rate and lateral position offset rate is void of any data derived from ground-based signals or an externally derived database.

The method according to paragraph [094], wherein determining the slant range and slant range rate is void of any data derived from ground-based signals or an externally derived database.

A method, comprising:
defining a precision approach path using a satellite-based position determination system, comprising defining a terminal target, a vertical plane, and an inclined horizontal plane, wherein the terminal target is a point located on a landing surface, wherein the vertical plane is perpendicular to a horizontal plane corresponding to the landing surface, wherein the inclined horizontal plane intersects the horizontal plane at a glide slope angle along a line that includes the terminal point, and wherein the vertical plane and inclined horizontal plane intersect along a line ending at the terminal target;
locating the aircraft relative to the precision approach path using an aircraft inertial position and an aircraft velocity as measured by a satellite-based position determination system located on the aircraft, comprising determining a lateral offset position and a lateral offset velocity from the vertical plane, a vertical offset position and vertical offset velocity from the inclined horizontal plane, and a slant range position and a slant range velocity from the terminal target; and
displaying a visual representation of the lateral position offset relative to the vertical plane, the vertical position offset relative to the inclined horizontal plane, and the slant range relative to the terminal target.

A system for performing onboard precision approach navigation, comprising:
a satellite-navigation receiver capable of receiving and processing aircraft inertial position and velocity signals;
a computing device configured to include the following engines:
   an inertial position engine;
   a location of interest engine;
   a vertical plane engine;
   an inclined horizontal plane engine;
   an offset engine;
   a slant range engine;
   a slant range rate engine; and
an automatic aircraft control actuator.

The system of paragraph [0104], further comprising a navigation display.

The system of paragraph [0104], wherein the inertial position engine is configured to use aircraft inertial position and velocity data from the receiver to determine and store an inertial location and velocity of the aircraft.

The system of paragraph [0104], wherein the location of interest engine is configured to use data from the receiver to determine and store a terminal point, wherein the terminal point is located on a landing surface.

The system of paragraph [0104], wherein the vertical plane engine constructs a plane oriented perpendicularly to a landing surface, the vertical plane including a terminal point located on the landing surface.

The system of paragraph [0104], wherein the inclined horizontal plane engine constructs a plane intersecting a landing surface along a line including a terminal point, wherein the inclined horizontal plane is inclined from the landing surface at a glide slope angle.

The system of paragraph [0104], wherein the offset engine calculates a first position and a first velocity of the aircraft relative to the vertical plane and a second position and a second velocity of the aircraft relative to the inclined horizontal plane.

The system of paragraph [0104], wherein, the slant range engine calculates an aircraft position relative to a terminal point.

The system of paragraph [0104], wherein the slant range rate engine calculates an aircraft velocity relative to a terminal point.

A method for satellite based precision relative navigation of an aircraft, comprising:
defining a target trajectory independent of ground-based navigation infrastructure, comprising defining a terminal target, a vertical surface, and an inclined horizontal plane, wherein the vertical surface is defined as one or more radius (radii) extending from a vertical line, and the vertical surface and inclined horizontal plane are normal to each other and intersect along an arc ending at the terminal target;
locating the aircraft relative to the target trajectory using an aircraft inertial position and an aircraft inertial velocity as measured by a satellite-based position determination system, comprising determining a lateral position offset, a lateral position offset rate, a vertical position offset, and a vertical position offset rate, wherein the lateral position offset and the lateral position offset rate are an aircraft position and velocity, respectively, relative to the vertical surface, and wherein the vertical position offset and the vertical position offset rate are an aircraft position and velocity, respectively, relative to the inclined horizontal plane; and
locating the aircraft relative to the terminal target using an aircraft inertial position and an aircraft velocity as measured by a satellite-based position determination system, comprising determining a slant range and a slant range rate, wherein the slant range and the slant range rate are an aircraft position and velocity, respectively, relative to the terminal target;
navigating to the terminal target, using a machine onboard the aircraft, wherein the machine is an autopilot coupled to a flight control system operable for controlling the aircraft.

What is claimed is:

1. A method for satellite based precision relative navigation of an aircraft, comprising:
defining a target trajectory independent of ground-based navigation infrastructure, comprising defining a terminal target, a vertical plane, and an inclined horizontal plane, wherein the vertical plane and the inclined horizontal plane are perpendicular to each other and intersect along a line ending at the terminal target;
locating the aircraft relative to the target trajectory using an aircraft inertial position and an aircraft inertial velocity as measured by a satellite-based position determination system, comprising determining a lateral position offset, a lateral position offset rate, a vertical position offset, and a vertical position offset rate, wherein the lateral position offset and the lateral position offset rate are an aircraft position and velocity, respectively, relative to the vertical plane, and wherein the vertical position offset and the vertical position offset rate are an aircraft position and velocity, respectively, relative to the inclined horizontal plane; and
locating the aircraft relative to the terminal target using an aircraft inertial position and an aircraft velocity as measured by a satellite-based position determination system, comprising determining a slant range and a slant range rate, wherein the slant range and the slant range rate are an aircraft position and velocity, respectively, relative to the terminal target;
navigating to the terminal target, using a machine onboard the aircraft, wherein the machine is an autopilot coupled to a flight control system operable for controlling the aircraft.

2. The method according to claim 1, further comprising displaying, using the machine, a visual representation of the lateral position offset relative to the vertical plane, the vertical position offset relative to the inclined horizontal plane, and the slant range relative to the terminal target.

3. The method according to claim 1, wherein the terminal target is a location defined by P_{A}(x_{A}, y_{A}, z_{A}) and P_{AA}(x_{AA}, y_{AA}, z_{AA}) and wherein the vertical plane is a first geometric surface defined by P_{AA}(x_{AA}, y_{AA}, z_{AA}), P_{BB}(x_{BB}, y_{BB}, z_{BB}), and P_{CC}(x_{CC}, y_{CC}, z_{CC}) and wherein the inclined horizontal plane is a second geometric surface defined by P_{A}(x_{A}, y_{A}, z_{A}), P_{B}(x_{B}, y_{B}, z_{B}), and P_{C}(x_{C}, y_{C}, z_{C}), and wherein N_{V} is a first unit vector that is normal to the vertical plane, and n_{H} is a second unit vector that is normal to the inclined horizontal plane, and wherein n_{V} and n_{H} are determined by
$${n}_{V} = \frac{{P}_{A A} {P}_{B B} \times {P}_{B B} {P}_{C C}}{\vert {P}_{A A} {P}_{B B} ‖ {P}_{B B} {P}_{C C} \vert} {n}_{H} = \frac{{P}_{A} {P}_{C} \times {P}_{A} {P}_{B}}{\vert {P}_{A} {P}_{C} ‖ {P}_{A} {P}_{B} \vert}$$
and define the vertical plane and the inclined horizontal plane, respectively, wherein PᵢPⱼ is the vector from location Pᵢ(xᵢ, yᵢ, zᵢ) to location Pⱼ(xⱼ, yⱼ, zⱼ), and PᵢPⱼ denotes the magnitude of the vector PᵢPⱼ.

4. The method according to claim 1, wherein defining the target trajectory further includes identifying three locations of interest defining a vertical plane, and three locations of interest defining an inclined horizontal plane, and selecting a seventh location of interest defining a terminal target, wherein the seventh location of interest is located on both the vertical plane and the inclined horizontal plane.

5. The method according to claim 4, wherein the slant range and the slant range rate from said terminal target to the aircraft position is independent of the target trajectory.

6. The method according to claim 4, wherein the vertical position offset and lateral position offset from the inclined horizontal plane and the vertical plane, respectively, are based on an aircraft inertial position and a relative aircraft position that is normal to the vertical plane and normal to the inclined horizontal plane.

7. The method according to claim 1, wherein determining the vertical position offset and lateral position offset is void of any data derived from ground-based signals or an externally derived database.

8. The method according to claim 1, wherein determining the vertical position offset rate and lateral position offset rate is void of any data derived from ground-based signals or an externally derived database.

9. The method according to claim 1, wherein determining the slant range and slant range rate is void of any data derived from ground-based signals or an externally derived database.

10. A method, comprising:
defining a precision approach path using a satellite-based position determination system, comprising defining a terminal target, a vertical plane, and an inclined horizontal plane, wherein the terminal target is a point located on a landing surface, wherein the vertical plane is perpendicular to a horizontal plane corresponding to the landing surface, wherein the inclined horizontal plane intersects the horizontal plane at a glide slope angle along a line that includes the terminal point, and wherein the vertical plane and inclined horizontal plane intersect along a line ending at the terminal target;
locating the aircraft relative to the precision approach path using an aircraft inertial position and an aircraft velocity as measured by a satellite-based position determination system located on the aircraft, comprising determining a lateral offset position and a lateral offset velocity from the vertical plane, a vertical offset position and vertical offset velocity from the inclined horizontal plane, and a slant range position and a slant range velocity from the terminal target; and
displaying a visual representation of the lateral position offset relative to the vertical plane, the vertical position offset relative to the inclined horizontal plane, and the slant range relative to the terminal target.

11. A system for performing onboard precision approach navigation, comprising:
a satellite-navigation receiver capable of receiving and processing aircraft inertial position and velocity signals;
a computing device configured to include the following engines:
an inertial position engine;
a location of interest engine;
a vertical plane engine;
an inclined horizontal plane engine;
an offset engine;
a slant range engine;
a slant range rate engine; and
an automatic aircraft control actuator.

12. The system of claim 11, further comprising a navigation display.

13. The system of claim 11, wherein the inertial position engine is configured to use aircraft inertial position and velocity data from the receiver to determine and store an inertial location and velocity of the aircraft.

14. The system of claim 11, wherein the location of interest engine is configured to use data from the receiver to determine and store a terminal point, wherein the terminal point is located on a landing surface.

15. The system of claim 11, wherein the vertical plane engine constructs a plane oriented perpendicularly to a landing surface, the vertical plane including a terminal point located on the landing surface.

16. The system of claim 11, wherein the inclined horizontal plane engine constructs a plane intersecting a landing surface along a line including a terminal point, wherein the inclined horizontal plane is inclined from the landing surface at a glide slope angle.

17. The system of claim 11, wherein the offset engine calculates a first position and a first velocity of the aircraft relative to the vertical plane and a second position and a second velocity of the aircraft relative to the inclined horizontal plane.

18. The system of claim 11, wherein the slant range engine calculates an aircraft position relative to a terminal point.

19. The system of claim 11, wherein the slant range rate engine calculates an aircraft velocity relative to a terminal point.

20. A method for satellite based precision relative navigation of an aircraft, comprising:
defining a target trajectory independent of ground-based navigation infrastructure, comprising defining a terminal target, a vertical surface, and an inclined horizontal plane, wherein the vertical surface is defined as one or more radius (radii) extending from a vertical line, and the vertical surface and inclined horizontal plane are normal to each other and intersect along an arc ending at the terminal target;
locating the aircraft relative to the target trajectory using an aircraft inertial position and an aircraft inertial velocity as measured by a satellite-based position determination system, comprising determining a lateral position offset, a lateral position offset rate, a vertical position offset, and a vertical position offset rate, wherein the lateral position offset and the lateral position offset rate are an aircraft position and velocity, respectively, relative to the vertical surface, and wherein the vertical position offset and the vertical position offset rate are an aircraft position and velocity, respectively, relative to the inclined horizontal plane; and
locating the aircraft relative to the terminal target using an aircraft inertial position and an aircraft velocity as measured by a satellite-based position determination system, comprising determining a slant range and a slant range rate, wherein the slant range and the slant range rate are an aircraft position and velocity, respectively, relative to the terminal target;
navigating to the terminal target, using a machine onboard the aircraft, wherein the machine is an autopilot coupled to a flight control system operable for controlling the aircraft.
